(19) United States
(12) Patent Application Publication
(10) Pub. No.: US 2025/0115495 A1
(43) Pub. Date: Apr. 10, 2025

(54) OXIDATION ELECTRODE FOR WATER TREATMENT AND WATER TREATMENT SYSTEM INCLUDING SAME

(71) Applicant: SK INNOVATION CO., LTD., Seoul (KR)

(72) Inventors: Tea Young LEE, Daejeon (KR); Tae Hwa JEON, Daejeon (KR)

(21) Appl. No.: 18/804,135

(22) Filed: Aug. 14, 2024

(30) Foreign Application Priority Data
Oct. 5, 2023 (KR) 10-2023-0132760

(51) Int. Cl. C02F 1/461; C02F 1/467

(52) U.S. Cl. CPC C02F 1/46109; C02F 1/4672; C02F 2001/46138

(57) ABSTRACT

Proposed is an oxidation electrode for water treatment. The oxidation electrode for water treatment includes a current collector, an intermediate layer disposed on the current collector, in which the intermediate layer is made of a metal oxide, and an electrode active material coating layer, in which the electrode active material coating layer includes an electrode active material in powder form. The oxidation electrode for water treatment has the advantage that it is stable because the degree of change in current over time is not large and has a high efficiency in removing organic substances in water to be treated.

### CROSS REFERENCE TO RELATED APPLICATION

The present application claims priority to Korean Patent Application No. 10-2023-0132760, filed Oct. 5, 2023, the entire contents of which is incorporated herein for all purposes by this reference.

### BACKGROUND

### Field of the Invention

Embodiments of the present disclosure relate to an oxidation electrode for water treatment and a water treatment system including the same.

### Description of the Related Art

With the industrial advancement, the properties of wastewater have also become more diverse. Non-degradable organic substances that are not removed through conventional biological water treatment processes cause environmental problems and pose a major threat to the ecosystem. As a solution to this, technologies that can electrochemically oxidize and control organic substances in the water system are being introduced, and are attracting attention as next-generation water treatment technologies because no additional chemicals are used.

However, the electrodes used in electrochemical water treatment technology have high manufacturing costs. Various studies are underway for making more economical electrodes.

In addition, since such electrodes used in electrochemical water treatment technology have the possibility of being oxidized in direct contact with wastewater, studies are also underway to ensure the stability of the electrodes themselves.

The foregoing is intended merely to aid in the understanding of the background of the present invention, and is not intended to mean that the present invention falls within the purview of the related art that is already known to those skilled in the art.

### SUMMARY

Embodiments of the present disclosure have been made keeping in mind the above issues occurring in the related art. An objective of the present disclosure is to provide an oxidation electrode for water treatment. Another objective of the present disclosure is to provide a water treatment system including the oxidation electrode.

Accordingly an embodiment of the present disclosure is directed to an oxidation electrode for water treatment, the oxidation electrode including a current collector; an electrode active material coating layer, wherein the electrode active material coating layer includes an electrode active material in powder form; and an intermediate layer disposed between the current collector and the electrode active material coating layer. The intermediate layer may be made of a metal oxide.

According to an embodiment, the current collector may include Ti.

According to an embodiment, the current collector may have a thickness of 0.25 to 2 mm.

According to an embodiment, the electrode active material may include boron doped diamond (BDD), Magneli phases, such as for example Magneli Ti₄O₇, a single atom catalyst, or a combination thereof.

According to an embodiment, the electrode active material is in powder form with a maximum dimension of 1 nm to 30 μm.

According to an embodiment, the electrode active material coating layer may have a thickness of 100 nm to 50 μm.

According to an embodiment, the metal oxide may include RuO₂, IrO₂, Pt/PtOₓ, TiO₂, or a combination thereof.

According to an embodiment, the intermediate layer may have a thickness of 10 to 1,000 nm.

According to another embodiment of the present disclosure, there is provided a method of manufacturing the above-described oxidation electrode, the method including providing a current collector; forming an intermediate layer on the current collector; and forming an electrode active material coating layer on the intermediate layer.

According to an embodiment, the current collector includes Ti and has a thickness of 0.25 to 2 mm, and wherein the electrode active material includes boron doped diamond (BDD), magneli phases, such as for example Magneli Ti₄O₇, a single atom catalyst, or a combination thereof.

According to an embodiment, the electrode active material is in powder form and has a maximum dimension of 1 nm to 30 μm.

According to an embodiment, the electrode active material coating layer has a thickness of 100 nm to 50 μm.

According to an embodiment, the metal oxide includes RuO₂, IrO₂, Pt/PtOₓ, TiO₂, or a combination thereof, and wherein the intermediate layer has a thickness of 10 to 1,000 nm.

According to another embodiment of the present disclosure, there is provided a water treatment system including the above-described oxidation electrode.

According to an embodiment, the current collector includes Ti and has a thickness of 0.25 to 2 mm, and wherein the electrode active material includes boron doped diamond (BDD), magneli phases, such as for example Magneli Ti₄O₇, a single atom catalyst, or a combination thereof.

According to an embodiment, the electrode active material is in powder form and has a maximum dimension of 1 nm to 30 μm.

According to an embodiment, the electrode active material coating layer has a thickness of 100 nm to 50 μm.

According to an embodiment, the metal oxide includes RuO₂, IrO₂, Pt/PtOₓ, TiO₂, or a combination thereof, and wherein the intermediate layer has a thickness of 10 to 1,000 nm.

According to another embodiment of the present disclosure, there is provided an oxidation electrode for water treatment, the oxidation electrode comprising a current collector; a metal oxide layer over the current collector; and an electrode active material coating layer of a thickness of 100 nm to 50 μm over the metal oxide comprising boron doped diamond (BDD), magneli phases, such as for example Magneli Ti₄O₇, a single atom catalyst, or a combination thereof.

According to an embodiment, the metal oxide comprises RuO₂; and wherein the electrode active material coating layer comprises BDD.

According to the embodiments of the present disclosure, it is possible to maintain a stable current during water treatment and provide an oxidation electrode with a long lifespan.

### BRIEF DESCRIPTION OF THE DRAWINGS

The above and other objectives, features, and other advantages of the embodiments of the present disclosure will be more clearly understood from the following detailed description when taken in conjunction with the accompanying drawings, in which:

FIG. 1 is a schematic diagram of a cross section of an oxidation electrode for water treatment according to an embodiment of the present disclosure;

FIGS. 2A to 2F are sectional images of an oxidation electrode for water treatment according to an embodiment of the present disclosure;

FIG. 3 is a surface scanning electron microscopy (SEM) image of an electrode active material coating layer according to an embodiment of the present disclosure;

FIGS. 4A to 4C are graphs illustrating a comparison of the change in current density when a constant voltage is applied to oxidation electrodes for water treatment of Preparation Example and Comparative Preparation Examples according to an embodiment of the present disclosure; and

FIG. 5 is a graph illustrating a comparison of the total organic carbon (TOC) removal performance for each oxidation electrode according to an embodiment of the present disclosure.

### DETAILED DESCRIPTION

The objectives, advantages, and features of the embodiments of the present disclosure will be more clearly understood from the following detailed description taken in conjunction with the accompanying drawings. However, the present disclosure is not limited to the below-described embodiments. Further, it is to be noted that, when the functions of conventional elements and the detailed description of elements related with the present disclosure may make the gist of the present disclosure unclear, a detailed description of those elements will be omitted.

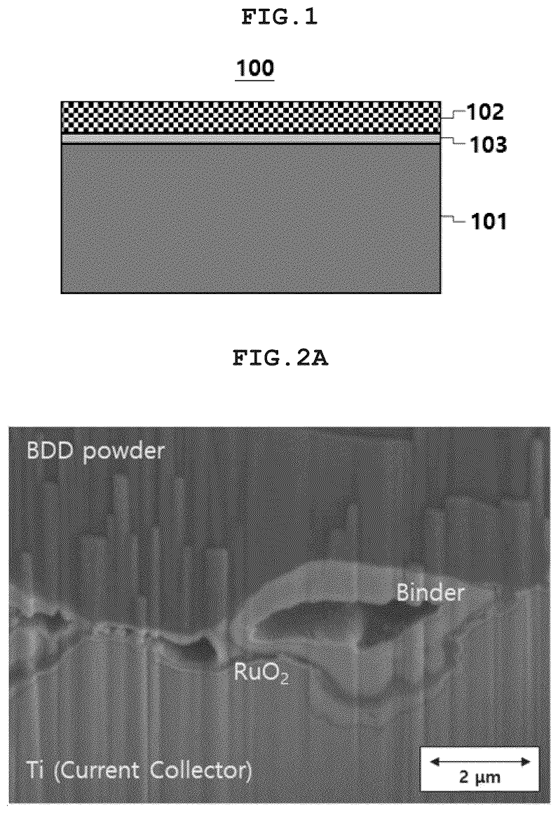

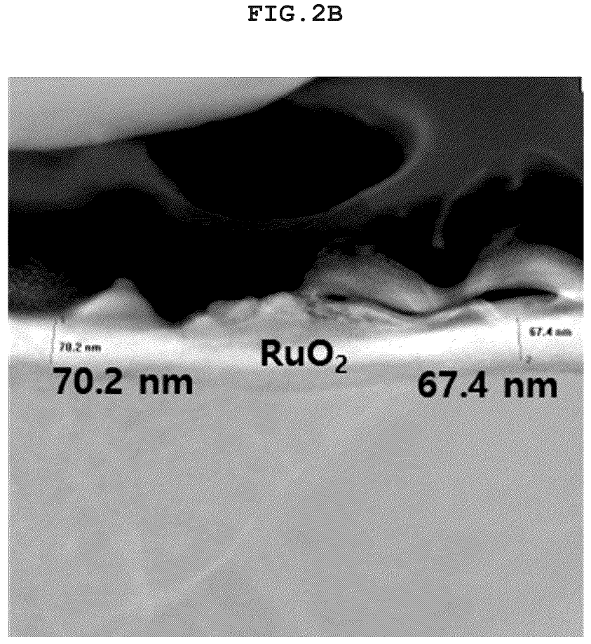

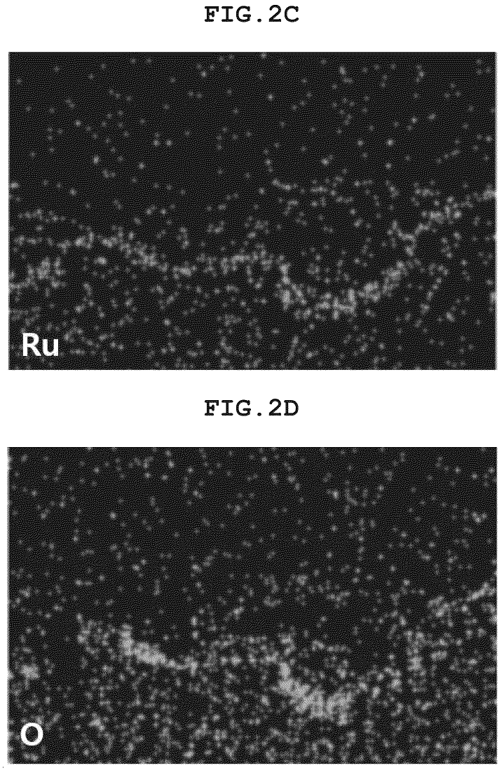

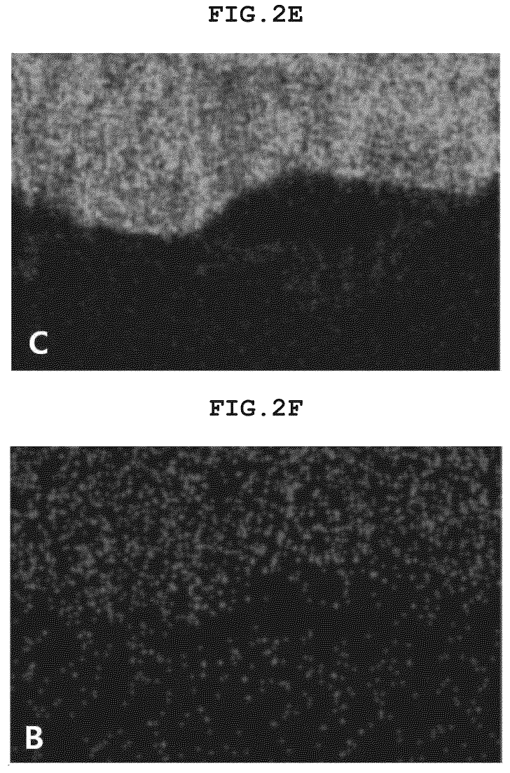

According to an embodiment of the present disclosure, an oxidation electrode for water treatment is provided. Referring to FIG. 1, the oxidation electrode (100) for water treatment includes a current collector (101); an electrode active material coating layer (102); and an intermediate layer (103) disposed between the current collector and the electrode active material coating layer. The oxidation electrode for water treatment according to the present disclosure has a stacked structure as illustrated in FIGS. 2A to 2F.

The current collector is a support that fixes an active material, and serves to transfer charges inside and outside the water system during electrochemical oxidation and reduction reactions when voltage or current is applied. When an oxidation reaction occurs in the active material coating layer of the oxidation electrode, electrons move to the current collector through the active material coating layer. The electrons transferred to the current collector again cause a reduction reaction on the surface of a reduction electrode in the water system through an external channel. Considering the role and function of the current collector as described above, it is advantageous for the current collector to have low electrical resistance.

In an embodiment the current collector may include Ti, stainless steel, or a combination thereof. Preferably, the current collector includes Ti. Ti is advantageous in transferring electrons due to its low electrical resistance.

In an embodiment the current collector may have a thickness of 0.25 to 2 mm. When, the thickness of the current collector is less than 0.25 mm, electron transfer from the electrode active material coating layer of the anode to the current collector is not smooth, so electrochemical reactions may not occur easily even when voltage is applied to the electrode. In an embodiment the current collector may have a thickness of preferably 0.25 to 1.0 mm, more preferably 0.25 to 0.5 mm.

The oxidation electrode for water treatment includes the electrode active material coating layer. When voltage is applied to the electrode, the electrode active material coating layer serves to receive electrons directly from organic substances in the water system on the surface thereof and oxidize the organic substances, or to indirectly generate oxidizing species and oxidize the organic substances through the oxidizing species.

The electrode active material coating layer includes an electrode active material in powder form. More specifically, the electrode active material coating layer according to an embodiment of the present disclosure may be in powder form. The electrode active material coating layer of the oxidation electrode is difficult to manufacture in the form of a large-area film due to size constraints of a synthesis reactor and cost issues, and direct synthesis on the intermediate layer is also not easy in terms of the process configuration. The electrode active material coating layer according to the present disclosure is manufactured by preparing the electrode active material in powder form rather than in film form and fixing the electrode active material on the intermediate layer, so it has the advantage of having a large surface area without the limitations of manufacturing cost, process, and reactor as described above.

In an embodiment the electrode active material coating layer may include a conductive binder. The conductive binder forms a bond between electrode active materials in powder form included in the electrode active material coating layer and at the same time causes the electrode active materials in powder form bonded to each other to be strongly attached to the intermediate layer.

In an embodiment the electrode active material may include boron doped diamond (BDD), magneli phases, such as for example Magneli Ti₄O₇, a single atom catalyst, or a combination thereof. The electrode active materials listed above have high chemical stability and, thus, are not oxidized and consumed directly even when current is applied. In addition, the electrode active materials listed above have high electrical conductivity. This allows organic substances in water to be treated to undergo an electron transfer reaction or efficiently generate oxidizing species on the surface of the electrode active material layer, thereby facilitating oxidation of the organic substances in the water to be treated.

In an embodiment the electrode active material may be loaded on carbon black or activated carbon. When the electrode active material is a single atom catalyst, it does not exist in a single atomic state, but exists in a state loaded on a carrier and may exhibit electrical activity. From the viewpoint of not inhibiting the electrical activity of the single atom catalyst, the carrier is preferably a material with high electrical conductivity, such as carbon black or activated carbon.

In an embodiment the electrode active material coating layer may have a thickness of 100 nm to 50 μm. When the thickness of the electrode active material coating layer is less than 100 nm, the degree to which the oxidation electrode attracts electrons from the organic substances in the water to be treated may not be sufficient to oxidize and degrade the organic substances. On the other hand, when the thickness of the electrode active material coating layer exceeds 50 μm, the ability to oxidize the organic substances is low compared to the cost of manufacturing the electrode active material coating layer, so it may not be cost-effective. In an embodiment the electrode active material coating layer may have a thickness of preferably 200 nm to 30 μm, more preferably 500 nm to 10 μm.

In an embodiment the electrode active material in powder form may have a maximum dimension of 1 nm to 30 μm. Here, the term “maximum dimension” refers to the largest diameter of the cross-section of the electrode active material in powder form. Due to a small maximum dimension as described above, the electrode active material in powder form can maximize the effective surface area of the oxidation electrode. This makes it possible to achieve higher organic substance degradation efficiency compared to an oxidation electrode having a planar surface of the same size. On the other hand, when the maximum dimension of the electrode active material in powder form is too small, i.e., less than 1 nm, electrical contact between the organic substances in the water to be treated and the surface of the oxidation electrode may be impaired, thereby reducing the efficiency of degrading the organic substances.

The oxidation electrode for water treatment includes the intermediate layer disposed between the current collector and the electrode active material coating layer. The intermediate layer serves to protect the current collector and prevents a decrease in electrical conductivity due to ohmic contact between the current collector and the electrode active material coating layer. Specifically, when a part of the current collector of the oxidation electrode for water treatment is exposed to an electrolyte in the water to be treated, the intermediate layer prevents a non-conducting metal oxide from being formed at the interface between the current collector and the electrode active material coating layer under application of current, thereby preventing high electrical resistance from occurring inside the electrode, or prevents the oxidized current collector from eluting and impairing electrode stability.

The intermediate layer is made of a metal oxide. Accordingly, the intermediate layer is not oxidized and eluted even when exposed to the electrolyte, thereby preventing direct contact between the current collector and the electrode active material coating layer. In addition, the intermediate layer according to the present disclosure can have the advantage of not lowering the electrical conductivity of the electrode even though it is a metal oxide by selecting an appropriate metal oxide and selecting an appropriate metal layer thickness to maintain a distance from the current collector that transfers charges.

In an embodiment the metal oxide may include RuO₂, IrO₂, Pt/PtOₓ, TiO₂, or a combination thereof. The metal oxides listed above have high electrical conductivity even though they are oxides and, thus, do not reduce the electrical conductivity of the oxidation electrode when constituting the intermediate layer. In addition, the metal oxides listed above are stable as oxides and, thus, do not elute even when power is applied. From the viewpoint of maintaining the electrical conductivity of the oxidation electrode, the metal oxide is most preferably RuO₂.

In an embodiment the intermediate layer may have a thickness of 10 to 1,000 nm. Since the intermediate layer is made of the metal oxide and has high oxidation stability as described above, even when it has a small thickness, it can completely block direct contact between the current collector and the electrode active material coating layer when current is applied. When the thickness of the intermediate layer is less than 10 nm, direct contact between the current collector and the electrode active material coating layer may not be completely blocked, thereby impairing the stability of the oxidation electrode. On the other hand, when the thickness of the intermediate layer exceeds 1,000 nm, the electrical conductivity of the oxidation electrode may be reduced due to the electrical resistance of the intermediate layer itself. In an embodiment the intermediate layer may have a thickness of preferably 20 to 500 nm, more preferably 50 to 100 nm.

In an embodiment the ratio of the thickness of the intermediate layer to the thickness of the current collector may be 1:100 to 20:100. When the ratio is less than 1:100, there is a possibility that the electrical conductivity of the oxidation electrode may be reduced due to ohmic contact between the intermediate layer and the electrode active material coating layer. On the other hand, when the ratio exceeds 20:100, there is a possibility that the electrical conductivity of the oxidation electrode may be reduced due to the electrical resistance of the intermediate layer itself. In an embodiment the ratio of the thickness of the intermediate layer to the thickness of the current collector may be preferably 3:100 to 17:100, more preferably 6:100 to 15:100.

According to an embodiment of the present disclosure, there is provided a method of manufacturing the above-described oxidation electrode for water treatment. The method includes providing a current collector; forming an intermediate layer on the current collector; and forming an electrode active material coating layer on the intermediate layer.

In an embodiment providing the current collector may include purifying the surface of the current collector. Since the current collector is exposed to air, it may include a trace amount of non-conductive metal oxide. The non-conductive metal oxide is an insulator and increases the electrical resistance of the oxidation electrode. Purifying the surface of the current collector includes removing the trace amount of non-conductive metal oxide formed as described above, and may be achieved by applying various methods. The methods are not limited as long as they can remove the non-conductive metal oxide on the current collector. As an example, the purifying of the surface of the current collector may be performed by immersing an insulator layer in a high-temperature acidic solution.

In an embodiment the forming of the intermediate layer on the current collector may include spray coating, spin coating, or brush coating an intermediate layer forming material on the current collector. The intermediate layer forming material may include a metal salt that is a precursor of a metal oxide constituting the intermediate layer, an acidic solution, and distilled water, and may be applied on the current collector by spray coating, spin coating, or brush coating. After application, drying and heat treatment are performed. As a result, the intermediate layer made of the metal oxide is formed on the current collector.

In an embodiment the forming of the electrode active material coating layer on the intermediate layer may include spray coating an electrode active material solution on the intermediate layer. The electrode active material solution includes an electrode active material in powder form along with a binder and a solvent, and is dispersed on the intermediate layer by spray coating to form the electrode active material layer. In an embodiment forming the electrode active material coating layer on the middle layer may include spray coating the electrode active material solution on the intermediate layer so that 3 to 10 mg of the electrode active material in powder form is included per unit area (cm²) of the intermediate layer.

According to an embodiment of the present disclosure, there is provided a water treatment system including an inventive oxidation electrode for water treatment. The water treatment system includes an electrode part including the above-described oxidation electrode for water treatment and a reduction electrode; a power supply that supplies power to the electrode part; and a reaction section that receives water to be treated including organic substances and brings the water to be treated into contact with the electrode part. The reaction section includes an inlet that allows the water to be treated to flow into the reaction section, and an outlet that discharges the water to be treated from which organic substances have been removed to the outside of the reaction section. Due to the stability of the above-described oxidation electrode for water treatment, the water treatment system has a long electrode replacement cycle, which is advantageous in terms of system maintenance costs. In addition, due to the high electrical conductivity of the above-described oxidation electrode for water treatment, the water treatment system can exhibit high organic substance degradation efficiency compared to the supplied power.

Hereinafter, the disclosed embodiments of the present disclosure will be more specifically described with reference to preferred examples, which should not be construed as examples limiting the embodiments of the present disclosure.

### Preparation Example: Manufacturing of Oxidation Electrode for Water Treatment

To remove a metal oxide that may have formed on a current collector, a 10 mm×20 mm×0.25 mm current collector made of Ti was immersed in a 10 wt % oxalic acid solution and heat-treated at a temperature of 80° C. for 1 hour.

Thereafter, Ru metal salt (RuCl₃) was dissolved in a solution of hydrochloric acid and distilled water mixed at a weight ratio of 1:1 to prepare a Ru metal precursor solution. The precursor solution was brush-coated on the above-described current collector. The coated current collector was dried at room temperature, and then heat-treated at 450° C. for 10 minutes. After repeating the cycle of brush coating, drying, and heat treatment as described above 10 times, the current collector was finally heat-treated at 450° C. for 1 hour to form an RuO₂ intermediate layer on the current collector.

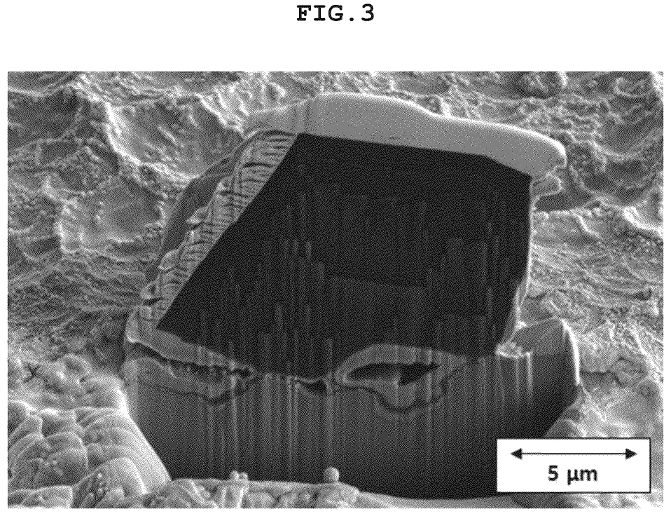

Thereafter, BDD (boron doped diamond) powder was selected and used as an electrode active material in powder form. A mixture solution was formed by mixing 20 mg of the BDD powder, 80 μl of a Nafion binder, and 2 ml of isopropanol. Nafion is a brand name for a sulfonated tetrafluoroethylene-based fluoropolymer-copolymer available by DuPont. The mixture solution was then sonicated for about 1 hour to ensure that the BDD powder was evenly dispersed within the mixture solution. The mixture solution prepared as described above was spray-coated on the intermediate layer to manufacture an oxidation electrode for water treatment. The manufactured oxidation electrode for water treatment included 5 mg of the BDD powder per unit area (cm²). The BDD powder was manufactured by Hunan Boromond EPT Co. Ltd. The overall cross-section of the manufactured oxidation electrode for water treatment is illustrated in FIG. 2A, and the intermediate layer showed a thickness distribution as illustrated in FIG. 2B. The distributions of Ru and O in the intermediate layer are illustrated in FIGS. 2C and 2D, respectively, and the distributions of carbon and boron in an electrode active material coating layer are illustrated in FIGS. 2E and 2F, respectively. The BDD powder of the electrode active material coating layer had a particle size as illustrated in FIG. 3.

### Comparative Preparation Example 1

An oxidation electrode for water treatment was manufactured in the same manner as in the Preparation Example described above, except that the operation of forming the RuO₂ intermediate layer was omitted. The manufactured oxidation electrode for water treatment was in a state in which a mixture solution including BDD powder was spray-coated on a current collector. Here, the oxidation electrode for water treatment included 5 mg of the BDD powder per unit area (cm²).

### Comparative Preparation Example 2

An oxidation electrode for water treatment was manufactured in the same manner as in the Preparation Example described above, except that the operation of coating the mixture solution including the BDD powder on the intermediate layer was omitted. The manufactured oxidation electrode for water treatment included only a current collector and an intermediate layer, and did not include an electrode active material coating layer.

### Experimental Example 1. Confirmation of Stability by Evaluating Change in Electrode Current Density

The oxidation electrodes for water treatment of the Preparation Example and Comparative Preparation Examples 1 and 2 were immersed in 30 mL of an electrolyte including 28 mg/L of TOC, and a constant voltage of 6 V was applied thereto. The constant voltage of 6 V was applied for 6 hours to confirm the change in current density while an electrochemical reaction occurred between the oxidation electrode for water treatment and the electrolyte including TOC.

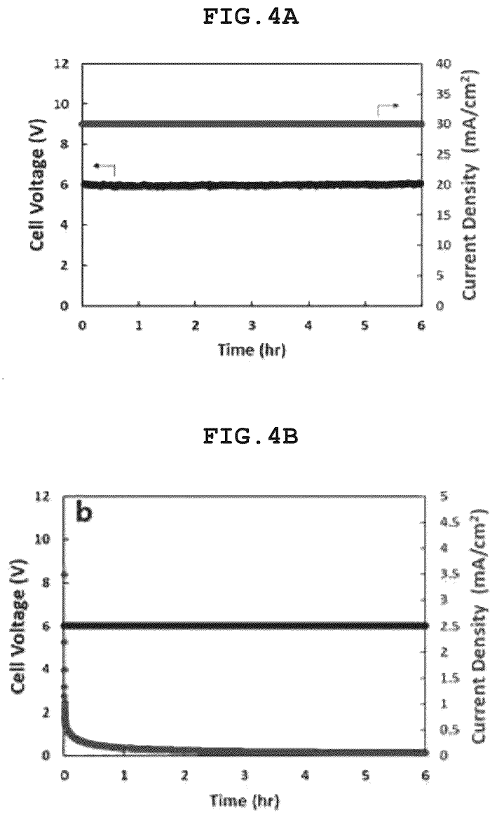

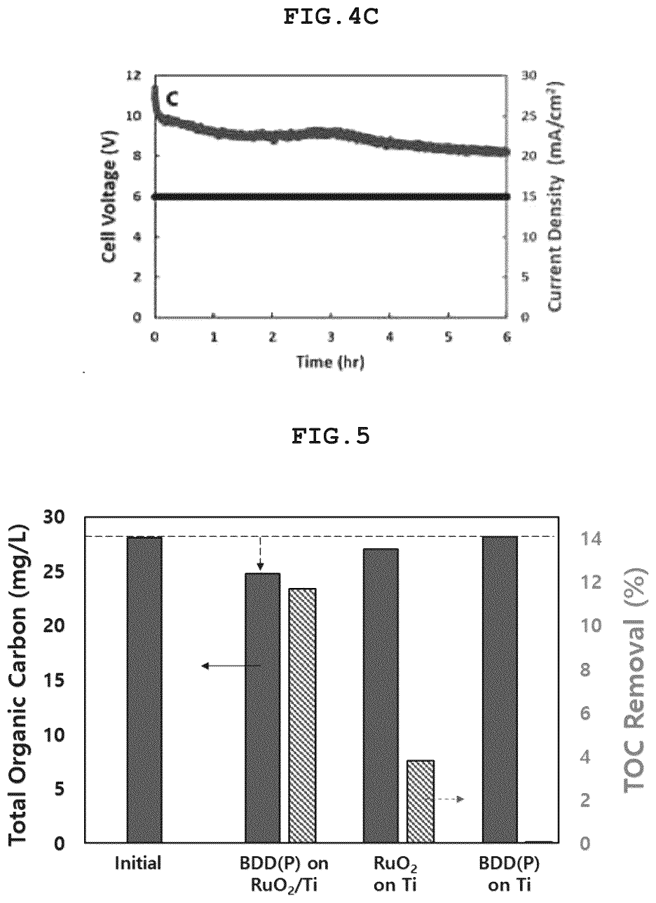

As illustrated in FIG. 4A, it was seen that the current density of the oxidation electrode for water treatment of the Preparation Example was maintained constant at about 30 mA/cm² for 6 hours.

As illustrated in FIG. 4B, it was seen that the current density of the oxidation electrode for water treatment of Comparative Preparation Example 1 dropped rapidly in the early period (within about 5 minutes after voltage application), and the current density converged to 0 about 3 hours after voltage application.

As illustrated in FIG. 4C, it was seen that the current density of the oxidation electrode for water treatment of Comparative Preparation Example 2 greatly decreased in the early period and gradually decreased thereafter. The current density of Comparative Preparation Example 2 was higher than that of Comparative Preparation Example 1, but lower than that of Preparation Example.

From the above experimental result, it was found that when an electrode including a current collector, an intermediate layer, and an electrode active material coating layer is used as an oxidation electrode as in Preparation Example, the current density could be maintained at a consistently high level without increasing or decreasing over time under a constant voltage, thus providing stability.

### Experimental Example 2. Confirmation of TOC Removal Performance for Each Electrode

The oxidation electrodes for water treatment of the Preparation Example and Comparative Preparation Examples 1 and 2 were immersed in 30 mL of an electrolyte including 28 mg/L of TOC, and a constant voltage of 6 V was applied thereto. After applying a constant voltage of 6 V for 6 hours, the change in TOC in the electrolyte was confirmed, and the results are illustrated in FIG. 5.

Referring to FIG. 5, it was seen that when using the oxidation electrode of the Preparation Example, a TOC removal rate of about 12% was observed, when using the oxidation electrode of Comparative Preparation Example 1, TOC was not removed at all, and when using the oxidation electrode of Comparative Preparation Example 2, a TOC removal rate of about 3.8% was observed.

From this, it was confirmed that the TOC removal rate was also the best when using the oxidation electrode for water treatment that includes all of the current collector, the intermediate layer, and the electrode active material coating layer as in Preparation Example.

From the above two experimental results, considering both the stability of the oxidation electrode and the effect of removing organic substances, it was concluded that it is desirable to use the oxidation electrode for water treatment that includes all of the current collector, the intermediate layer, and the electrode active material coating layer.

While the present disclosure has been described in detail with embodiments thereof, such embodiments are illustrative and are not given as limitations. The embodiments are only examples of the present disclosure, and it will be understood by those skilled in the art that the embodiments of the present disclosure can be modified or changed in various forms without departing from the technical concept of the present disclosure.

Simple modifications or changes of the embodiments of the present disclosure belong to the scope of the present disclosure, and the detailed scope of the embodiments of the present disclosure will be more clearly understood by the accompanying claims.

What is claimed is:

1. An oxidation electrode for water treatment, the oxidation electrode comprising:
a current collector;
an electrode active material coating layer, wherein the electrode active material coating layer includes an electrode active material in powder form; and
an intermediate layer disposed between the current collector and the electrode active material coating layer, wherein the intermediate layer is made of a metal oxide.

2. The oxidation electrode of claim 1, wherein the current collector includes Ti.

3. The oxidation electrode of claim 1, wherein the current collector has a thickness of 0.25 to 2 mm.

4. The oxidation electrode of claim 1, wherein the electrode active material includes boron doped diamond (BDD), magneli phases, such as for example Magneli Ti₄O₇, a single atom catalyst, or a combination thereof.

5. The oxidation electrode of claim 1, wherein the electrode active material in powder form has a maximum dimension of 1 nm to 30 μm.

6. The oxidation electrode of claim 1, wherein the electrode active material coating layer has a thickness of 100 nm to 50 μm.

7. The oxidation electrode of claim 1, wherein the metal oxide includes RuO₂, IrO₂, Pt/PtOₓ, TiO₂, or a combination thereof.

8. The oxidation electrode of claim 1, wherein the intermediate layer has a thickness of 10 to 1,000 nm.

9. A method of manufacturing the oxidation electrode of claim 1, the method comprising:
providing a current collector;
forming an intermediate layer on the current collector; and
forming an electrode active material coating layer on the intermediate layer.

10. The method of claim 9, wherein the current collector includes Ti and has a thickness of 0.25 to 2 mm, and wherein the electrode active material includes boron doped diamond (BDD), magneli phases, such as for example Magneli Ti₄O₇, a single atom catalyst, or a combination thereof.

11. The method of claim 9, wherein the electrode active material is in powder form and has a maximum dimension of 1 nm to 30 μm.

12. The method of claim 9, wherein the electrode active material coating layer has a thickness of 100 nm to 50 μm.

13. The method of claim 9, wherein the metal oxide includes RuO₂, IrO₂, Pt/PtOₓ, TiO₂, or a combination thereof, and wherein the intermediate layer has a thickness of 10 to 1,000 nm.

14. A water treatment system including the oxidation electrode of claim 1.

15. The water treatment system of claim 14, wherein the current collector includes Ti and has a thickness of 0.25 to 2 mm, and wherein the electrode active material includes boron doped diamond (BDD), magneli phases, such as for example Magneli Ti₄O₇, a single atom catalyst, or a combination thereof.

16. The water treatment system of claim 14, wherein the electrode active material is in powder form and has a maximum dimension of 1 nm to 30 μm.

17. The water treatment system of claim 14, wherein the electrode active material coating layer has a thickness of 100 nm to 50 μm.

18. The water treatment system of claim 14, wherein the metal oxide includes RuO₂, IrO₂, Pt/PtOₓ, TiO₂, or a combination thereof, and wherein the intermediate layer has a thickness of 10 to 1,000 nm.

19. An oxidation electrode for water treatment, the oxidation electrode comprising:
a current collector;
a metal oxide layer over the current collector; and
an electrode active material coating layer of a thickness of 100 nm to 50 μm over the metal oxide comprising boron doped diamond (BDD), magneli (Ti₄O₇), a single atom catalyst, or a combination thereof.

20. The oxidation electrode for water treatment of claim 19,
wherein the metal oxide comprises RuO₂; and
wherein the electrode active material coating layer comprises BDD.
